(19) United States
(12) Patent Application Publication
(10) Pub. No.: US 2005/0223406 A1
(43) Pub. Date: Oct. 6, 2005

(54) Vehicle entertainment system including a detachable video system with a hard drive based video source

(76) Inventor: Christopher J. Vitito, Celebration, FL (US)

Correspondence Address: WELSH & FLAXMAN LLC, 2000 DUKE STREET, SUITE 100, ALEXANDRIA, VA, 22314, US

(21) Appl. No.: 11/153,455

(22) Filed: Jun. 16, 2005

Related U.S. Application Data
(63) Continuation-in-part of application No. 10/982,896, filed on Nov. 8, 2004.
(60) Provisional application No. 60/517,862, filed on Nov. 7, 2003.

(51) Int. Cl. H04N 7/18

(52) U.S. Cl. 725/77; 725/74; 725/75

(57) ABSTRACT

A vehicle entertainment system includes a video system having a video monitor and a hard drive, and a cradle secured within an automobile. The cradle is shaped and dimensioned for selectively receiving and securely holding the video system.

### CROSS REFERENCE TO RELATED APPLICATION

This application is a continuation-in-part of U.S. patent application Ser. No. 10/982,896, filed Nov. 8,2004, entitled “AUTOMOBILE ENTERTAINMENT SYSTEM”, which is currently pending, and is based upon U.S. Provisional Patent Application Nos. 60/517,862, filed Nov. 7, 2003, entitled “AUTOMOBILE ENTERTAINMENT SYSTEM”.

### BACKGROUND OF THE INVENTION

1. Field of the Invention

The invention relates to a vehicle entertainment system. More particularly, the invention relates to an entertainment system detachably integrating a hard drive video source and video monitor within an automobile.

2. Description of the Prior Art

Entertainment systems for automobiles are well known. As such, many advances have been made in the development of entertainment systems that make the otherwise tedious task of riding in an automobile more bearable. In addition to the development of overhead systems pioneered by the present inventor, systems that mount within the headrest of an automobile have also been developed.

These headrest entertainment systems allow multiple individuals to view a variety of different video sources within the same vehicle. However, and as those skilled in the art will certainly appreciate, it is desirable to provide added versatility to these entertainment systems. The present invention attempts to accomplish this by providing a system whereby the video system may be selectively removed from an automobile and used at other locations. The present invention further enhances the functionality of the video system by integrating a hard drive with an automobile entertainment system.

### SUMMARY OF THE INVENTION

It is, therefore, an object of the present invention to provide a vehicle entertainment system including a video system having a video monitor and a hard drive. The entertainment system also includes a cradle secured within an automobile. The cradle is shaped and dimensioned for selectively receiving and securely holding the video system.

It is also an object of the present invention to provide an entertainment system wherein the video system includes electrical connectors shaped and dimensioned for selective engagement with electrical connectors formed within the cradle.

It is another object of the present invention to provide an entertainment system wherein the cradle is mounted within a headrest.

It is a further object of the present invention to provide an entertainment system wherein the cradle is secured to a ceiling of the automobile.

It is also another object of the present invention to provide an entertainment system including at least one docking station to which the video system may be selectively secured when not coupled to the cradle.

It is yet another object of the present invention to provide an entertainment system wherein the cradle includes a connecting mechanism for selective attachment of the video system thereto.

It is also an object of the present invention to provide an entertainment system wherein the connecting mechanism includes a release button for selective release of the video system from the cradle.

It is a further object of the present invention to provide an entertainment system wherein the connecting mechanism includes a latch member for selective coupling of the video system to the cradle.

Other objects, advantages and salient features of the invention will become apparent from the following detailed description, which taken in conjunction with the annexed drawings, discloses a preferred, but non-limiting, embodiment of the subject invention.

### BRIEF DESCRIPTION OF THE DRAWING

FIG. 1 is a front perspective view of an automobile entertainment system in accordance with the present invention.

FIG. 2 is a cross sectional view of the housing of the video system shown in FIG. 1.

FIGS. 3 and 4 are front perspective views showing the entertainment system with the video system coupled to the headrest and detached from the headrest.

FIGS. 5, 6, 7 and 8 are views of entertainment systems in accordance with alternate embodiments of the present invention.

FIG. 9 shows the video system of FIG. 1 mounted within a dash docking station.

FIG. 10 shows the video system of FIG. 1 mounted within a mobile docking station.

FIG. 11 shows the video system of FIG. 1 mounted within a static docking station.

FIG. 12 is a front view of an automobile entertainment system in accordance with an alternate embodiment of the present invention.

FIGS. 13 and 14 are front perspective views showing the entertainment system of FIG. 12 with the video system coupled to the cradle and detached from the cradle.

FIG. 15 shows the video system of FIG. 12 mounted within a dash docking station.

FIG. 16 shows the video system of FIG. 12 mounted within a mobile docking station.

FIG. 17 shows the video system of FIG. 12 mounted within a static docking station.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

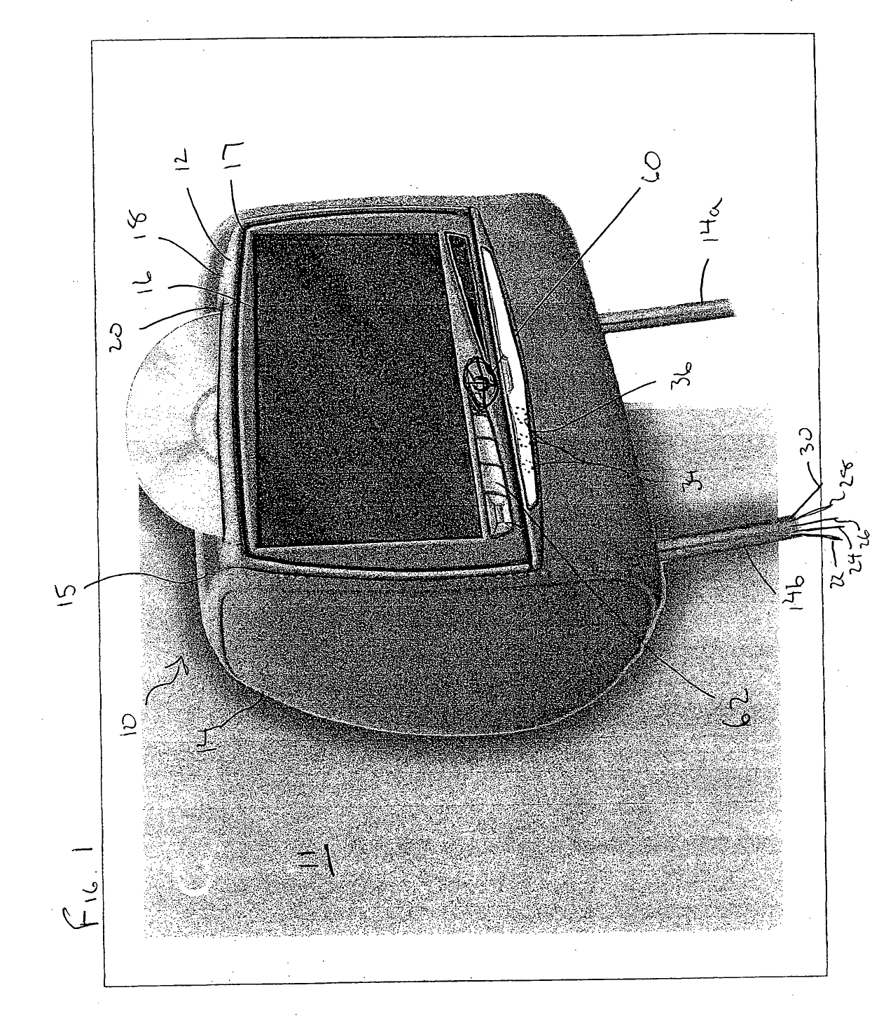

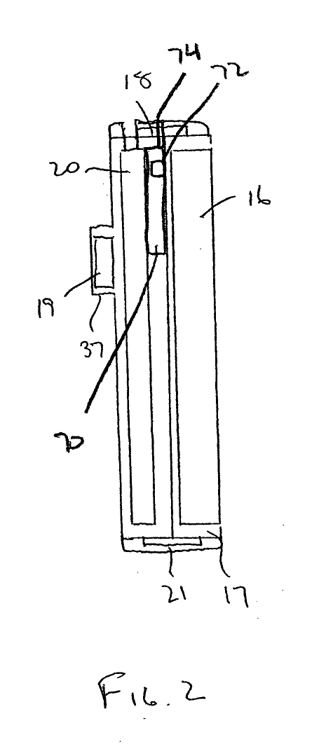

With reference to FIGS. 1 to 11, and in accordance with a first embodiment of the present invention, an automobile entertainment system 10 is disclosed. The automobile entertainment system 10 is composed of a series of video and audio components integrated within an automobile 11. Although the present system is described herein for use within an automobile, the system could readily be employed in various vehicles, for example, boats or planes, without departing from the spirit of the present invention. In particular, the entertainment system 10 includes a video system 12 detachably mounted within a standard headrest 14 of an automobile 11. The video system 12 generally includes a video monitor 16 for presenting video content and a video source 20 integrated therewith.

In accordance with a preferred embodiment of the present invention, the video source(s) 15 includes a DVD player 20 and hard drive 70 coupled to the video monitor 16 for the transmission of video content thereto. The DVD player 20, hard drive 70 and/or other video source(s) are integrated within the same housing 18 as the video monitor 16. However, and as discussed below in greater detail, the video source may take a variety of forms without departing from the spirit of the present invention; for example, and not limited to, satellite video systems and Bluetooth wireless based systems.

The video source 15 includes a hard drive 70 as noted above. The hard drive 70 is used by storing desired video content therein for later playback on the video monitor 18. In order to implement the hard drive 70 within the present video system 12, it is provided with an associated processor 72 and input/output 74.

As those skilled in the art will appreciate, the processor 72 is similar to those known within the electronics industry and commonly used in providing for playback, storage, deletion, etc., in conjunction with currently available digital video recorders. As for the input/output 74, it is designed for connection with other video sources to allow for the ready transfer of information therebetween. With this in mind, the input/output may be provided with a variety of commonly available wired and/or wireless connection structures allowing for ready connection between the input/output 74 (and ultimately the hard drive 70) and a remote video source being used to transfer information to or from the hard drive 70.

The video system 12 is mounted along the rear portion of the headrest 14 such that an individual sitting in the rear seat of the automobile 11 may watch the media presented on the video monitor 16 without disturbing the driver of the automobile 11.

The video monitor 16, DVD player 20, hard drive 70 and associated control components are mounted within the housing 18. As those skilled in the art will certainly appreciate, the video monitor 16 is pivotally mounted within a recess 17 formed in the housing 18. In accordance with a preferred embodiment, the video monitor 16 is a TFT LCD screen. However, it is contemplated that other monitor constructions, for example, plasma, Ultra High Definition VGA, touch screen VGA, organic LED, fabric based monitors (e.g., flexible TFT) etc., may be used without departing from the spirit of the present invention.

With regard to the DVD player 20, it is integrally molded within the housing 18 and positioned for insertion of DVDs behind the video monitor 16. By mounting the DVD player 20 in this way, a stable structure is developed that is well adapted for the automobile environment. The hard drive 70 is mounted within the housing 18 in a manner providing for use thereof in an efficient and effective manner.

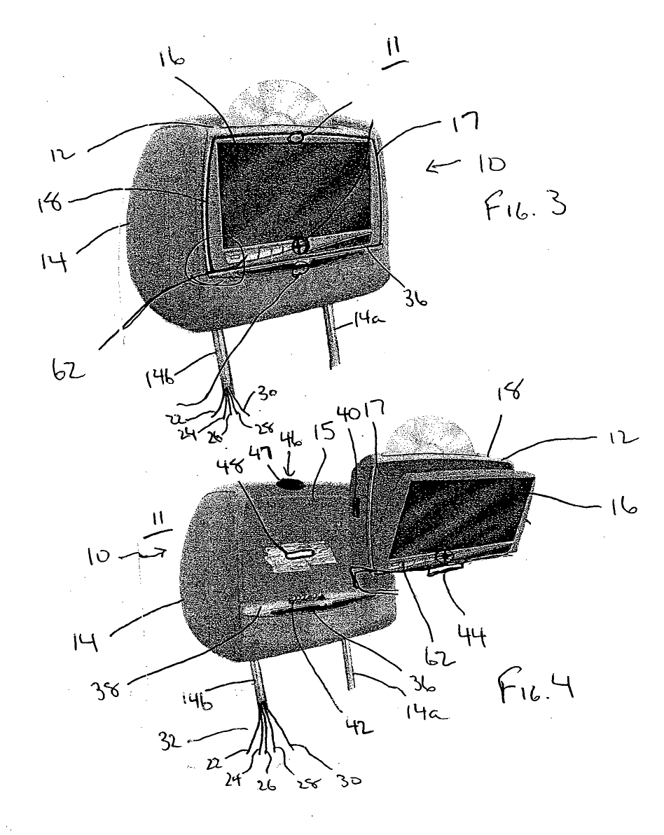

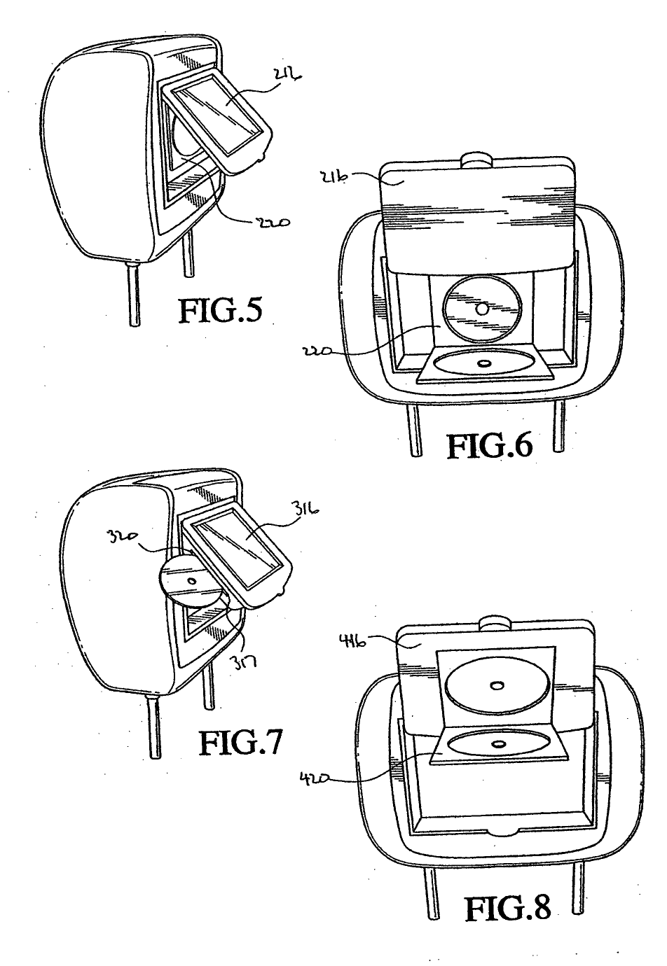

While the DVD player 20 is disclosed as being a slot-loaded design with insertion behind the video monitor, the DVD player could take a variety of other forms while still being integrated with the video monitor 16. With reference to FIGS. 5 and 6, the DVD player 220 may be positioned beneath the pivotally mounted video monitor 216. With reference to FIG. 7, the DVD player 320 may be integrated with the video monitor 316 and facilitate access via a side loading slot 317. Referring to FIG. 8, the DVD player 420 is integrated with the underside of the video monitor 416 and the DVD is snapped into DVD player 420 when the monitor 416 is pivoted upward. In addition, the DVD player may be designed with a built-in TV tuner for providing the user with a choice of video sources.

As briefly mentioned above, the housing 18 is detachably secured to the headrest 14. In particular, the housing 18, including the video monitor 16, DVD player 20, hard drive 70 and other related components, is detachably mounted within a recess 23 formed in the headrest 14. As such, the video system 12 may be removed from the automobile 11 and used at a variety of locations apart from the automobile 11. As will be discussed below in greater detail, the video system 12 may be used alone or in conjunction with a docking station 50′, 50″, 50′″. Once removed, the video system 12 may be used in other automobiles 11 or within an individual's home. When used alone, a battery pack may be connected to the video system 12 and the video system 12 can thereby become a portable entertainment system.

A cradle 38 shaped and dimensioned for receiving the video system 12 is provided within the recess 23 of the headrest 14. As will be discussed below in greater detail, similar cradles 38′, 38″, 38′″ may be provided at other locations permitting use of the video system 12 at other remote locations. It is contemplated that such a cradle 38, 38′, 38″, 38′″ would be much like the docking stations utilized with laptop computers wherein individuals are permitted to readily remove the laptop from a docking station for use at another location remote from the docking station.

More specifically, the cradle 38 utilized in the headrest 14 includes quick release electrical connections 42 for the audio input 22, audio output 24, video input 26, video output 28 and power supply 30 (although an embodiment with only a simple power supply connection is contemplated). The video system 12 similarly includes mating electrical connections 44 for transmitting electricity and a/v signals between the cradle 38 and the video system 12. In particular, when the video system 12 is mounted upon the cradle 38, the respective electrical connections 42, 44 mate to provide for the transmission of power and a/v signals between the video system 12 and the cradle 38. As those skilled in the art will certainly appreciate, other readily removable electrical connections for other purposes may also be supplied if one determines they are so needed.

In addition to the electrical connections 42 provided on the cradle 38, the cradle 38 also includes a connecting mechanism 46 designed for selectively retaining the video system 12 within the cradle 38. The connecting mechanism 46 permits ready and selective attachment of the video system 12 to the headrest 14 while preventing vibrations and other damaging movements that commonly occur in an automobile 11.

In accordance with a preferred embodiment of the present invention, the connecting mechanism 46 includes a release button 47 and a latch member 48. The release button 47 is actuated to rotate the latch member 48 and permit removal of the video system 12 from the cradle 38. Insertion of the video system 12 within the headrest 14 is achieved by simply setting the video system 12 within the cradle 38 and applying sufficient force to the video system for overcoming the rotational force of the latch member 48 to force the video system 12 into a secure position. While a particular coupling structure is disclosed in accordance with a preferred embodiment of the present invention, those skilled in the art will appreciate that a variety of selectively releasable coupling structures may be employed without departing from the spirit of the present invention.

The entertainment system 10 further includes cables 32 extending through the headrest 14. These cables ultimately link audio, video and power to the cradle 38 and video system 12. More specifically, the cradle 38 and video system 12 are electrically connected to the remainder of the automobile 11 via electrical communication lines extending through one or both of the extension arms 14a, 14b of the headrest 14. For example, and as will be discussed below in substantial detail, a video input 22, video output 24, audio input 26, audio output 28 and power source 30, may be respectively connected to the cradle 38 for ultimate connection with the video system 12 via the mating electrical connections 42, 44 of the respective cradle 38 and video system 12.

Specific wiring arrangements and linking of various video systems within an automobile in accordance with preferred embodiments of the present invention are disclosed in U.S. patent application Ser. No. 10/920,425, entitled “AUTOMOBILE ENTERTAINMENT SYSTEM”, filed Aug. 18, 2004, which is incorporated herein by reference, U.S. patent application Ser. No. 10/895,111, entitled “AUTOMOBILE ENTERTAINMENT SYSTEM”, filed Jul. 21, 2004, which is incorporated herein by reference, U.S. patent application Ser. No. 10/895,110, entitled “AUTOMOBILE ENTERTAINMENT SYSTEM LINKING MULTIPLE VIDEO SYSTEM FOR COORDINATED SHARING OF VIDEO CONTENT”, filed Jul. 21, 2004, which is incorporated herein by reference, U.S. patent application Ser. No. 10/895,086, entitled “HOUSING FOR AN AUTOMOBILE ENTERTAINMENT SYSTEM”, filed Jul. 21, 2004, which is incorporated herein by reference, U.S. patent application Ser. No. 10/895,099, entitled “INSTALLATION APPARATUS FOR AN AUTOMOBILE ENTERTAINMENT SYSTEM”, filed Jul. 21, 2004, which is incorporated herein by reference, U.S. patent application Ser. No. 10/920,431, entitled “AUTOMOBILE ENTERTAINMENT SYSTEM”, filed Aug. 18, 2004, which is incorporated herein by reference, and U.S. patent application Ser. No. 10/920,430, entitled “AUTOMOBILE ENTERTAINMENT SYSTEM”, filed Aug. 18, 2004, which is incorporated herein by reference.

As briefly mentioned above, a DVD player 20 and hard drive 70 are integrated with the video monitor 16 to form the video system 12 of the present invention. The DVD player 20 and hard drive 70 are integrated with the video monitor 16 to facilitate convenient viewing of media on the video monitor 16 while also conserving space within the limited confines of the automobile 11. For example, by integrating the DVD player 20 with the video monitor 16, individuals using the video monitor 16 may conveniently insert DVDs within the video system 12 without reaching within another part of the automobile 11. Similarly, by providing a hard drive 70, the users need not clutter the car with DVDs and other videos, but may preload the hard drive 70 with desired material.

With this in mind, it is contemplated the present video system 12 may be positioned within any headrest 14 employed in a car, truck, SUV, or van. The video system 12 may be placed within all vehicle headrests (and, with regard to automobiles having three rows of seats, video systems may be positioned within both the front seat headrests and the second seat headrests). In this way, individuals sitting on opposite sides of an automobile 11 can watch different video content on different video systems 12. In fact, different videos may be viewed, and wireless headphones may still be employed, by utilizing a multi-channel IR transmitter in conjunction with the present system.

The present video system 12 is provided with the ability to offer a variety of functionalities. These functionalities may be hardwired or programmed within the video system 12 or the functionalities may be added in a modular manner via an expansion slot 40 provided within the video system 12. Contemplated functionalities include, but are not limited to satellite radio (for example, Serius, XM), Pictel phone, satellite television (for example, DirecTV), GPS guidance systems, quick release battery packs, memory cards, wireless internet access (for example, Wi-Fi), Bluetooth, digital video recorders, digital video reception and recording, digital video inputs, video conferencing, cellular digital, cellular digital with a camera, USB capabilities, Blue sphere, hot swap hard drive, satellite video import card, wireless video import card, etc.

Enhanced usage is further provided by the inclusion of RCA ports 34, or other a/v input/outputs, formed within the cradle 38 and contained behind a cover 36 which may be selectively opened to reveal the ports 34. As those skilled in the art will certainly appreciate, the inputs/outputs may take a variety of forms including single jack input/outputs. The inclusion of these ports 34 allows for ready attachment of the present video system 12 to other remote a/v sources (for example, game consoles, portable digital music players, etc.).

In addition, and in accordance with a preferred embodiment, a broadcast television receiver 19 is integrated with the video monitor 16 and/or the headrest 14. More particularly, and with reference to FIG. 2, the housing 18 is provided with a rear recess 37 shaped and dimensioned for receiving a television receiver 19. The television receiver 19 may, therefore, be wired for use in conjunction with the video monitor 16 in a manner known to those skilled in the art.

The television receiver 19 is further provided with an antenna 21. The antenna 21 is electrically connected to the television receiver 19 for the transmission of over-the-air signals. As those skilled in the art will certainly appreciate, the antenna may also be wirelessly connected to the receiver without departing from the spirit of the present invention. The antenna 21 is substantially U-shaped and is wrapped about the housing 18. While a U-shaped antenna wrapped about the housing is disclosed in accordance with a preferred embodiment of the present invention, the antenna may be oriented within a variety of locations within the headrest without departing from the spirit of the present invention or the television receiver may operate without the antenna.

Control of the video system 12, including the video monitor 16, DVD player 20, hard drive 70 and other components of the video system 12, is facilitated by the provision of control buttons along the outer surface of the video system 12. In accordance with a preferred embodiment of the present invention, the control buttons take the form of a multifunction controller 60 permitting movement of a cursor shown upon various interfaces displayed upon the video monitor 16. In addition, conventional control buttons 62 may also be provided for control of traditional functions. In addition to the provision of manual control buttons 62, the video system 12 may further include a remote control (not shown) such that an individual need not actually touch the video system 12 to control the video content or the volume generated by the video system 12. Once again, and as those skilled in the art will certainly appreciate, a variety of remote control systems may be utilized without departing from the spirit of the present invention.

As briefly mentioned above, the present video system 12 is adapted for removal from the headrest 14 of an automobile 11 for use at a variety of other locations. In accordance with a preferred embodiment of the present invention, the other locations are provided with a docking station 50′, 50″, 50′″ including auxiliary cradles 38′, 38″, 38′″ shaped and dimensioned for receiving the video system 12 and coupling the video system 12 to power sources and a/v sources in a manner similar to the cradle 38 used in conjunction with the headrest 14.

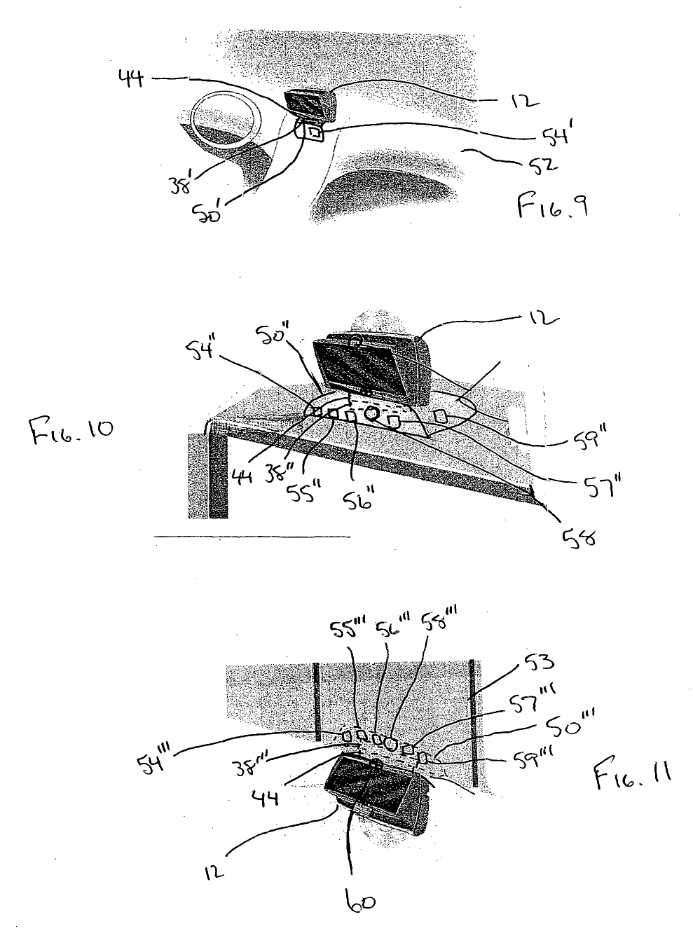

For example, and with reference to FIG. 9, a docking station 50′ for use in conjunction with the dash 52 of a conventional automobile 11 is disclosed. The docking station 50′ includes an auxiliary cradle 38′ (with electrical connections and a connecting mechanism (not shown)) shaped and dimensioned for receiving and securely holding the video system 12 and coupling the video system 12 to power sources and a/v sources in a manner similar to the cradle 38 used in conjunction with the headrest 14. The docking station 50′ is mounted upon the dash 52 of an automobile 11 and is wired for connection to a power source and a/v sources (not shown). In addition, the dash docking station 50′ may include an integrated satellite receiver 54′ for providing satellite content to the passenger of the automobile 11 by transmitting the satellite signal through the cradle 38′ and into the video system 12 via the respective electrical connections of the cradle 38′ and the video system 12. This embodiment is particularly useful where the video system 12 includes functionality relating to the provision of GPS guidance information. With this in mind, the driver will be able to selectively use the video system 12 for accessing guidance information when needed and return the video system 12 to the headrest 14 when guidance information is no longer needed. It is contemplated such a system will be provided with a safety mechanism limiting what the driver can view (for example, preventing the viewing of videos but allowing the viewing of the navigation system) when the monitor is facing him or her.

With reference to FIG. 10, a mobile docking station 50″ may also be provided. The mobile docking station 50″ also includes an auxiliary cradle 38″ (with electrical connections and a connecting mechanism (not shown)) shaped and dimensioned for receiving and securely holding the video system 12 and coupling the video system 12 to power sources and a/v sources in a manner similar to the cradle 38 used in conjunction with the headrest 14. The docking station 50″ may include a battery pack 55″, a/v inputs 56″, a/v outputs 57″, Internet capability, speakers 58″, cable input 59″ and/or an integrated satellite receiver 54″. These components are linked to the video system 12 via the cradle 38″ which transmits the relevant signals to and from the video system 12 via the respective electrical connections of the cradle 38″ and the video system 12.

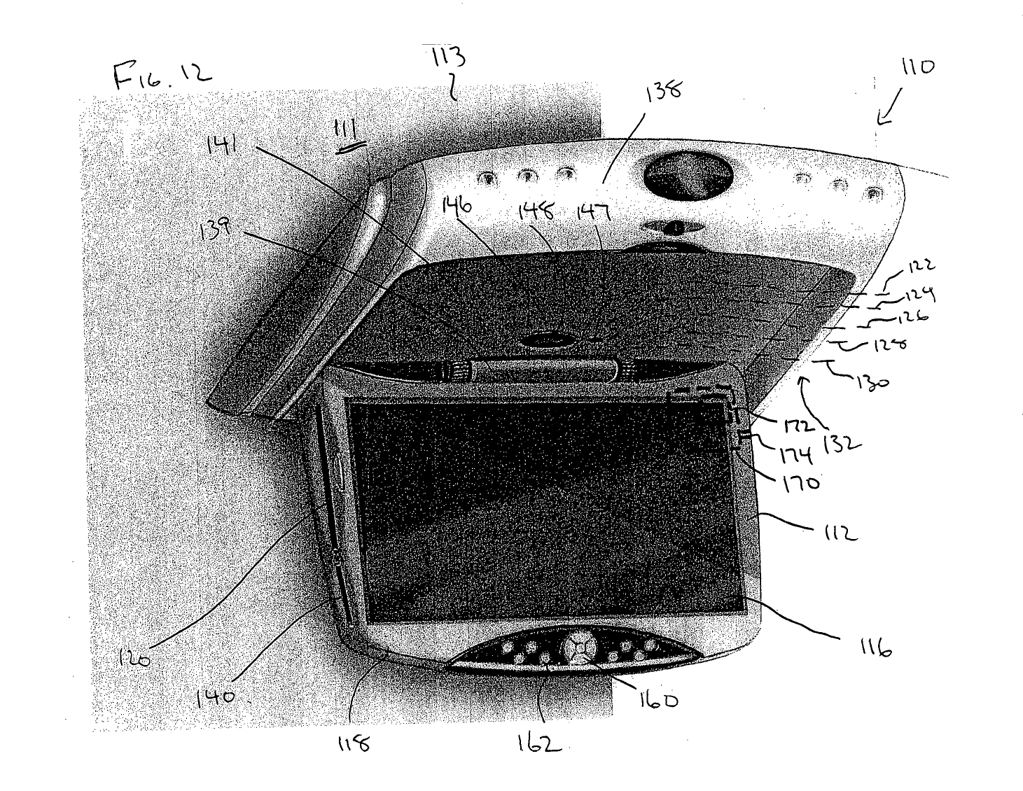

With reference to FIG. 11, yet a further embodiment of a docking station 50′″ is disclosed. This docking station 50′″ is adapted for static mounting within a household, office or other locations (for example, beneath a kitchen cabinet 53′″). The docking station 50′″ includes an auxiliary cradle 38′″ (with electrical connections and a connecting mechanism (not shown)) shaped and dimensioned for receiving and securely holding the video system 12 and coupling the video system to power sources and a/v sources in a manner similar to the cradle 38 used in conjunction with the headrest 14. The docking station 50′″ may include a battery pack 55′″, a/v inputs 56′″, a/v outputs 57′″, Internet capability, speakers 58′″, cable input 59′″ and/or an integrated satellite receiver 54′″. These components are linked to the video system 12 via the cradle 38′″ which transmits the relevant signals to and from the video system 12 via the respective electrical connections of the cradle 38′″ and the video system 12.

As shown in FIG. 11, when the video system 12 is mounted beneath a kitchen cabinet 53 as shown, it may be necessary to mount the video system 12 upside down when compared to its mounting within an automobile headrest 14. With this in mind, the video system 12 is provided with the ability to rotate to the image shown on the video monitor 16 so that the video system 12 may be used in a variety of orientations. The possible rotation of the image shown on the video monitor 16 is complemented by the multifunctional controller 60 that adjusts to rotation of the image such that the controller 60 is calibrated to function in accordance with the orientation of the screen image.

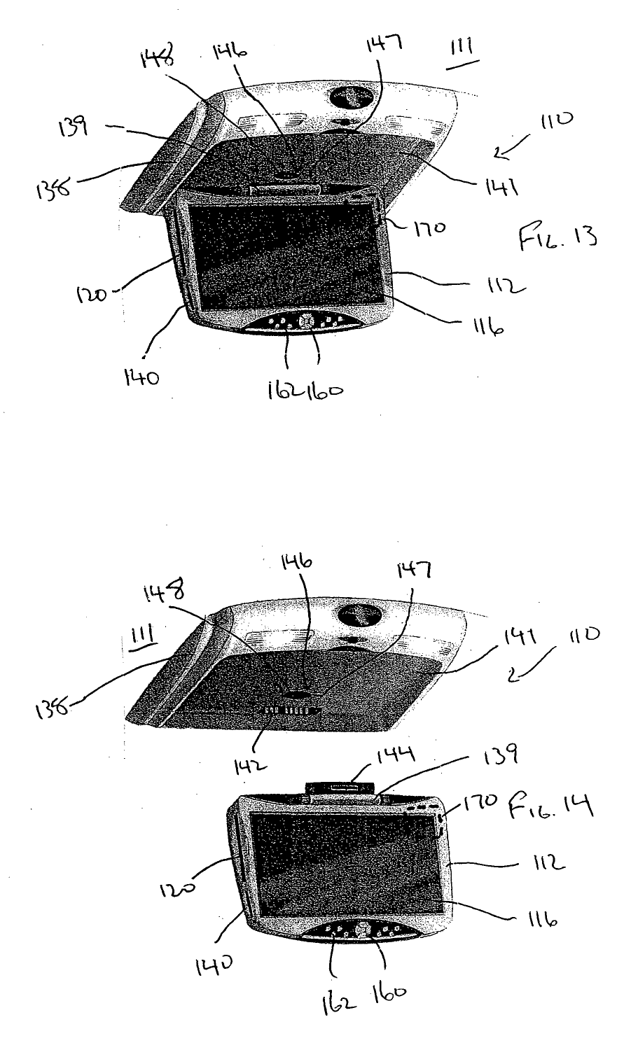

In addition to providing for the inclusion of a removable video system 12 within the headrest 14 of an automobile 11 as shown above with reference to FIGS. 1 to 11, it is further contemplated an entertainment system 110 providing for a selectively removable video system 112 mounted within the ceiling of an automobile 111. In accordance with this alternate embodiment, and with reference to FIGS. 12 to 17, the video system 112 is selectively mounted to an overhead cradle 138.

As those skilled in the art will certainly appreciate, the ceiling mounted system and the headrest mounted system may be integrated within a single vehicle to provide for a choice between a ceiling mount use and a headrest mount use. This would require the use of a universal cradle structure allowing the owner to move the video system from one location to another location without needing to incur the cost of purchasing a video system for each location. The individual could place the video system within the ceiling mounted cradle when many people are riding the automobile and move the video system to the headrest when only one passenger is viewing the media present upon the video system.

As with the embodiment disclosed above, the video system 112 is detachably mounted within a cradle 138 secured to the ceiling of an automobile 111. The video system 112 generally includes a video monitor 116 for presenting media content and a video source 115 integrated therewith.

In accordance with a preferred embodiment of the present invention, the video source(s) includes a DVD player 120 and hard drive 170 coupled to the video monitor 116 for the transmission of video content thereto. The DVD player 120, hard drive 170 and/or other video source(s) are integrated within the same video housing 118 as the video monitor 116. However, and as discussed above with reference to the embodiments disclosed in FIGS. 1 to 11, the video source may take a variety of forms without departing from the spirit of the present invention.

The video system 112 is mounted to the cradle 138 for viewing in the rear of the automobile 111. With this in mind, the housing 118 of the video system 112 is provided with a pivotal coupling member 139 allowing the video system 112 to pivot relative to the cradle 138 for storage when the video system 112 is not in use. It is also contemplated that the coupling member 139 may be designed to provide for rotation of the housing 118 about multiple axes. In this way, the video system 112 may be freely rotated to improve viewing regardless of the where the video system 112 is being used.

The video monitor 116, DVD player 120, hard drive 170 and associated control components are mounted within the housing 118. In accordance with a preferred embodiment, the video monitor 116 is a TFT LCD screen. However, it is contemplated that other monitor constructions, for example, plasma, Ultra High Definition VGA, touch screen VGA, organic LED, fabric based monitors (e.g., flexible TFT) etc., may be used without departing from the spirit of the present invention.

With regard to the DVD player 120, it is integrally molded within the housing 118 and positioned for insertion of the DVDs behind the video monitor 116. By mounting the DVD player 120 in this way, a stable structure is developed that is well adapted for the automobile environment. While the DVD player 120 is disclosed as being a slot-loaded design with insertion behind the video monitor 116, the DVD player could take a variety of other forms without departing from the spirit of the present invention.

As with the prior headrest mounted embodiment, the video source 115 also includes a hard drive 170. The hard drive 170 is used by storing desired video content therein for later playback on the video monitor 118. In order to implement the hard drive 170 within the present video system 112, it is provided with an associated processor 172 and input/output 174.

As those skilled in the art will appreciate, the processor 172 is similar to those known within the electronics industry and commonly used in providing for playback, storage, deletion, etc., in conjunction with currently available digital video recorders. As for the input/output 174, it is designed for connection with other video sources to allow for the ready transfer of information therebetween. With this in mind, the input/output may be provided with a variety of commonly available connection structures allowing for ready connection between the input/output 174 (and ultimately the hard drive 170) and a remote video source being used to transfer information to or from the hard drive 170.

As briefly mentioned above, the housing 118 is detachably secured to the ceiling mounted cradle 138. In particular, the housing 118, including the video monitor 116, DVD player 120, hard drive 170 and other related components, is detachably mounted within a recess 141 formed in the cradle 138. As such, the video system 112 may be removed from the automobile 111 and used at a variety of locations apart from the automobile 111. As will be discussed below in greater detail, the video system 112 may be used alone or in conjunction with a docking station 150′, 150″, 150′″. Once removed, the video system 112 may be used in other automobiles or within an individual's home. When used alone, a battery pack may be connected to the video system 112 and the video system 112 can thereby become a portable entertainment system.

The cradle 138 is shaped and dimensioned for receiving and securing the video system 112 to the ceiling of the automobile 111. As was discussed above with reference to the headrest based system, similar cradles 138′, 138″, 138′″ may be provided at other locations permitting use of the video system 112 at other remote locations.

More specifically, the cradle 138 utilized in accordance with a preferred embodiment of the present invention includes quick release electrical connections 142 for the audio input 122, audio output 124, video input 126, video output 128 and power supply 130 (although an embodiment with only a simple power supply connection is contemplated). The video system 112 similarly includes mating electrical connections 144 for transmitting electricity and a/v signals between the cradle 138 and the video system 112. In particular, when the video system 112 is mounted upon the cradle 138, the respective electrical connections 142, 144 mate to provide for the transmission of power and a/v signals between the video system 112 and the cradle 138. As those skilled in the art will certainly appreciate, other readily removable electrical connections for other purposes may also be supplied if one determines they are so needed.

In addition to the electrical connections provided on the cradle 138, the cradle 138 also includes a connecting mechanism 146 designed for selectively retaining the video system 112 within the cradle 138. The connecting mechanism 146 permits ready and selective attachment of the video system 112 to the ceiling of the automobile 111 while preventing vibrations and other damaging movements that commonly occur in an automobile 111.

In accordance with a preferred embodiment of the present invention, the connecting mechanism 146 includes a release button 147 and a latch member 148. The release button 147 is actuated to rotate the latch member 148 and permit removal of the video system 112 from the cradle 138. Insertion of the video system 112 within the cradle recess 141 is achieved by simply setting the video system 112 within the recess 141 of the cradle 138 and overcoming the rotational force of the latch member 148 to force the video system 112 into a secure position. While a particular coupling structure is disclosed in accordance with a preferred embodiment of the present invention, those skilled in the art will appreciate that a variety of selectively releasable coupling structures may be employed without departing from the spirit of the present invention.

The entertainment system further includes cables 132 extending through the ceiling and the cradle 138. These cables 132 ultimately link audio, video and power to the cradle 138 and video system 112. More specifically, the cradle 138 and video system 112 are electrically connected to the remainder of the automobile 111 via electrical communication lines in a manner know to those skilled in the art.

As discussed above, specific wiring arrangements and linking of various video systems within an automobile in accordance with preferred embodiments of the present invention are disclosed in commonly owned patent applications that are incorporated herein by reference.

The present video system 112 is provided with the ability to offer a variety of functionalities. These functionalities may be hardwired or programmed within the video system 112 or the functionalities may be added in a modular manner via an expansion slot 140 provided within the video system 112. Contemplated functionalities include, but are not limited to satellite radio (for example, Serius, XM), satellite television (for example, DirecTV), GPS guidance systems, quick release battery packs, memory cards, wireless internet access (for example, Wi-Fi), Bluetooth, digital video recorders, digital video reception and recording, digital video inputs, video conferencing, cellular digital, cellular digital with a camera, etc.

In addition, and in accordance with a preferred embodiment, a broadcast television receiver and an antenna as discussed above with reference to the prior embodiment shown in FIG. 2 is integrated with the video system 112.

Control of the video system 112, including the video monitor 116, DVD player 120 and other components of the video system 112, is facilitated by the provision of control buttons along the outer surface of the video system 112. In accordance with a preferred embodiment of the present invention, the control buttons take the form of a multifunction controller 160 permitting movement of a cursor shown upon various interfaces displayed upon the video. In addition, conventional control buttons 162 may also be provided for control of traditional functions. In addition to the provision of manual control buttons, the video system 112 may further include a remote control (not shown) such that an individual need not actually touch the video system 112 to control the video content or the volume generated by the video system 112.

As briefly mentioned above, the present video system is adapted for removal from the ceiling cradle 138 of an automobile 111 for use at a variety of other locations. In accordance with a preferred embodiment of the present invention, the other locations are provided with docking stations 150′, 150″, 150′″ including auxiliary cradles 138′, 138″, 138′″ shaped and dimensioned for receiving the video system 112 and coupling the video system 112 to power sources and a/v sources in a manner similar to the cradle 138 used in conjunction with the ceiling.

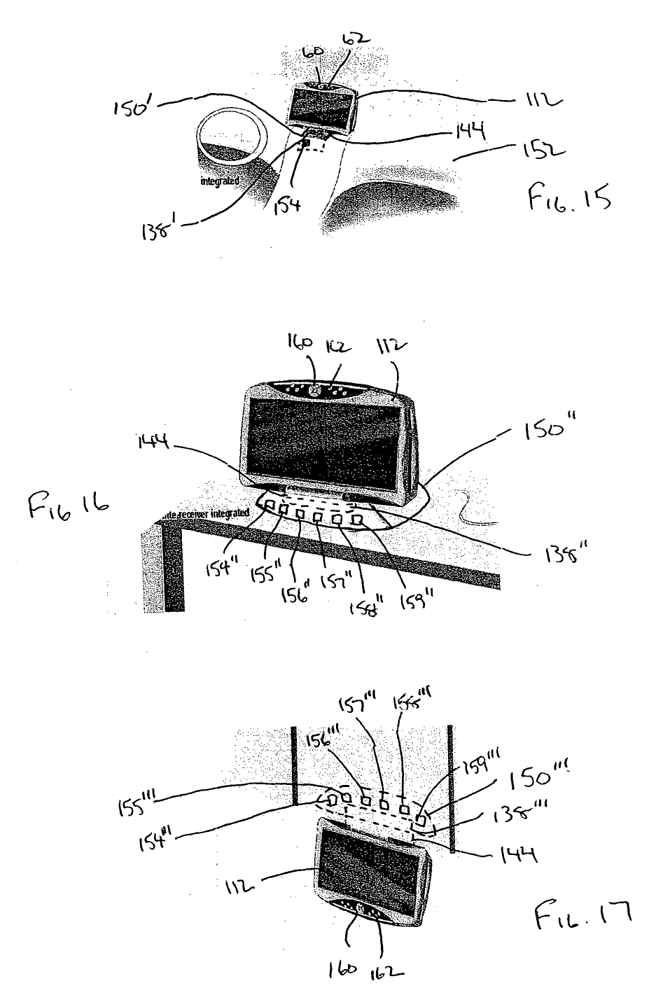

For example, and with reference to FIG. 15, a docking station 150′ for use in conjunction with the dash 152 of a conventional automobile 111 is disclosed. The docking station 150′ includes an auxiliary cradle 138′ (with electrical connections and a connecting mechanism (not shown)) shaped and dimensioned for receiving and securely holding the video system 112 and coupling the video system 112 to power sources and a/v sources in a manner similar to the cradle 138 used in conjunction with the headrest 114. The docking station 150′ is mounted upon the dash 152 of an automobile 111 and is wired for connection to a power source and a/v sources. In addition, the dash docking station 150′ may include an integrated satellite receiver 154′ for providing satellite content to the passengers of the automobile 111 by transmitting the satellite signal through the cradle 138′ and into the video system 112 via the respective electrical connections of the cradle 138′ and the video system 112. This embodiment is particularly useful where the video system 112 includes functionality relating to the provision of GPS guidance information. With this in mind, the driver will be able to selectively use the video system 112 for accessing guidance information when needed and return the video system 112 to the ceiling cradle 138 when guidance information is no longer needed.

With reference to FIG. 16, a mobile docking station 150″ may also be provided. The mobile docking station 150″ also includes an auxiliary cradle 138″ (with electrical connections and a connecting mechanism (not shown)) shaped and dimensioned for receiving and securely supporting the video system 112 and coupling the video system 112 to power sources and a/v sources in a manner similar to the cradle 138 used in conjunction with the ceiling. The docking station 150″ may include a battery pack 155″, a/v inputs 156″, a/v outputs 157″, Internet capability, speakers 158″, cable input 159″ and/or an integrated satellite receiver 154″. These components are linked to the video system 112 via the cradle 138″ which transmits the relevant signals to and from the video system 112 via the respective electrical connections of the cradle 138″ and the video system 112.

As shown in FIGS. 15 and 16, when the video system 112 is mounted to the docking stations 150′, 150″, it may be necessary to mount the video system 112 upside down when compared to its mounting within an automobile 111. With this in mind, the video system 112 is provided with the ability to rotate to the image shown on the video monitor 116 so that the video system 112 may be used in a variety of orientations. The possible rotation of the image shown on the video monitor 116 is complemented by the multifunctional controller 160 that adjusts to rotation of the image such that the controller 160 is calibrated to function in accordance with the orientation of the screen image.

With reference to FIG. 17, yet a further embodiment of a docking station 150′″ is disclosed. This docking station 150′″ is adapted for static mounting within a household, office or other locations (for example, beneath a kitchen cabinet 153). The docking station 150′″ includes an auxiliary cradle 138′″ (with electrical connections and a connecting mechanism (not shown)) shaped and dimensioned for receiving and securely supporting the video system 112 and coupling the video system 112 to power sources and a/v sources in a manner similar to the cradle 138 used in conjunction with the ceiling. The docking station 150′″ may include a battery pack 155′″, a/v inputs 156′″, a/v outputs 157′″, Internet capability, speakers 158′″, cable input 159′″ and/or an integrated satellite receiver 154′″. These components are linked to the video system 112 via the cradle 138′″ which transmits the relevant signals to and from the video system 112 via the respective electrical connections of the cradle 138′″ and the video system 112.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A vehicle entertainment system, comprising:
a video system including a video monitor and a hard drive;
a cradle secured within an automobile, the cradle being shaped and dimensioned for selectively receiving and securely holding the video system.

2. The entertainment system according to claim 1, wherein the video system includes electrical connectors shaped and dimensioned for selective engagement with electrical connectors formed within the cradle.

3. The entertainment system according to claim 1, wherein the cradle is mounted within a headrest.

4. The entertainment system according to claim 1, wherein the cradle is secured to a ceiling of the automobile.

5. The entertainment system according to claim 1, further including at least one docking station to which the video system may be selectively secured when not coupled to the cradle.

6. The entertainment system according to claim 5, wherein the video system includes electrical connectors shaped and dimensioned for selective engagement with electrical connectors formed within the docking station.

7. The entertainment system according to claim 1, wherein the cradle includes a connecting mechanism for selective attachment of the video system thereto.

8. The entertainment system according to claim 7, wherein the connecting mechanism includes a release button for selective release of the video system from the cradle.

9. The entertainment system according to claim 8, wherein the connecting mechanism includes a latch member for selective coupling of the video system to the cradle.
